(19) United States
(12) Patent Application Publication
(10) Pub. No.: US 2022/0238866 A1
(43) Pub. Date: Jul. 28, 2022

(54) MATERIAL FOR FORMING POSITIVE ELECTRODE ACTIVE MATERIAL LAYER AND NONAQUEOUS ELECTROLYTE SECONDARY BATTERY USING THE MATERIAL FOR FORMING POSITIVE ELECTRODE ACTIVE MATERIAL LAYER

(71) Applicant: Prime Planet Energy & Solutions, Inc., Tokyo (JP)

(72) Inventor: Kenji YOKOE, Okazaki-shi (JP)

(21) Appl. No.: 17/579,598

(22) Filed: Jan. 20, 2022

(30) Foreign Application Priority Data
Jan. 27, 2021 (JP) 2021-011049

(51) Int. Cl. H01M 4/36; H01M 4/505; H01M 4/525; H01M 4/62; H01M 10/0525

(52) U.S. Cl. CPC H01M 4/366; H01M 4/505; H01M 2004/028; H01M 4/625; H01M 10/0525; H01M 4/525

(57) ABSTRACT

Provided is a material for forming a positive electrode active material layer that containing a positive electrode active material comprising a coating portion that contains TiO₂, and that allows suitably reducing reaction resistance. A material for forming a positive electrode active material layer disclosed herein contains a positive electrode active material and carbon nanotubes. The positive electrode active material comprises a core portion containing a lithium-transition metal complex oxide, and a coating portion that covers at least part of the surface of the core portion. The coating portion contains TiO₂.

### CROSS REFERENCE TO RELATED APPLICATIONS

The present application claims priority to Japanese Patent Application No. 2021-011049 filed on Jan. 27, 2021, the entire contents whereof are incorporated in the present specification by reference.

### BACKGROUND

The present disclosure relates to a material for forming a positive electrode active material layer. The present disclosure also relates to a nonaqueous electrolyte secondary battery that utilizes the material for forming a positive electrode active material layer.

Nonaqueous electrolyte secondary batteries such as lithium ion secondary batteries are suitably used as portable power sources in personal computers, mobile terminals and the like, as an also as power sources for vehicle drive in for instance battery electric vehicles (BEV), hybrid electric vehicles (HEV) and plug-in hybrid electric vehicles (PHEV). These nonaqueous electrolyte secondary batteries typically have a positive electrode, a negative electrode and a nonaqueous electrolyte. The positive electrode generally contains a positive electrode active material capable of storing and releasing ions that serve as charge carriers.

Further improvements in the performance of nonaqueous electrolyte secondary batteries have been demanded in recent years. Examples of methods for meeting such demands include methods that involve coating the surface of a positive electrode active material with a metal oxide or the like. For example, Japanese Patent Application Publication No. 2015-099646 discloses a positive electrode active material wherein a coating layer of titanium dioxide (TiO₂) is formed, on the surface of particles, so that titanium (Ti) is present in an amount of from 0.2 to 1.5 mass %, relative to the active material. The above publication indicates that high-rate discharge performance (and also output characteristics) is improved in a lithium ion secondary battery that utilizes such a positive electrode active material.

### SUMMARY

A conceivable method for further improving the output characteristics may involve for instance increasing the coating amount of TiO₂ on the surface of the positive electrode active material. However, TiO₂ itself has electron insulating properties, and accordingly there have been limits as to increasing the coating amount of TiO₂, from the viewpoint of preventing drops in output characteristics due to an increase in reaction resistance (i.e. charge transfer resistance) (for instance the examples in Japanese Patent Application Publication No. 2015-099646 above reveal that output characteristics drop when the content of Ti in the active material is 3.0 mass % or more). A demand exists thus for the development of a positive electrode material that allows suitably achieving drops in reaction resistance also in aspects in which the positive electrode material includes a positive electrode active material of increased TiO₂ coating amount.

It is a main object of the present disclosure, arrived at in the light of the above considerations, to provide a material for forming a positive electrode active material layer that contains a positive electrode active material having a covering portion (hereafter also referred to as “coating portion”) containing TiO₂, and in which reaction resistance can be suitably reduced.

To attain the above goal, the present disclosure provides a material for forming a positive electrode active material layer that contains a positive electrode active material and carbon nanotubes. The positive electrode active material has a core portion that contains a lithium-transition metal complex oxide, and a coating portion that covers at least part of the surface of the core portion. The coating portion is characterized by containing TiO₂.

The inventors found that a nonaqueous electrolyte secondary battery of excellent output characteristics can be obtained, also in a case where the coating amount of TiO₂ is increased relative to that in conventional art, thanks to a material for forming a positive electrode active material layer and that results from adding carbon nanotubes, as a conductive material, to a positive electrode active material having a coating portion that contains TiO₂, and perfected the present disclosure on the basis of that finding. Although not a particularly restrictive interpretation, the above effect can arguably be achieved by virtue of the fact that electron conductivity can be suitably ensured as a result of entangling of carbon nanotubes with the positive electrode active material, also in cases where the coating amount of TiO₂ is increased. Moreover, it is deemed that the presence of the carbon nanotubes translates into a greater contact area between the positive electrode active material and TiO₂, and contributes to improving output characteristics.

In a preferred aspect of the material for forming a positive electrode active material layer disclosed herein, a Ti coverage ratio is from 5 to 21%, wherein the Ti coverage ratio is calculated by following equation:

Ti coverage ratio (%)={Ti element ratio/(Ti element ratio+Me element ratio)}×100 (I), where:

Ti element ratio: An element ratio (atomic %) of titanium (Ti) on the surface of the positive electrode active material being calculated by XPS analysis,
Me element ratio: An element ratio (atomic %) of a metal element (Me) other than an alkali metal from among the metal elements that make up the core portion.

A positive electrode active material having a high Ti coverage ratio, from 5 to 21%, is suitably as a target in which the art disclosed herein can be adopted.

In a preferred aspect of the material for forming a positive electrode active material layer disclosed herein, the carbon nanotubes include multi-walled carbon nanotubes.

Among carbon nanotubes, multi-walled carbon nanotubes exhibit excellent thermal and chemical stability, and accordingly can be preferably used in the art disclosed herein.

In a preferred aspect of the material for forming a positive electrode active material layer disclosed herein, the content of the carbon nanotubes is 5 mass % or less relative to 100 mass % as the total solids of the material for forming a positive electrode active material layer.

A material for forming a positive electrode active material layer having such a configuration is preferred since in that case a nonaqueous electrolyte secondary battery can be achieved in which the battery capacity is suitably maintained.

In another aspect, the present disclosure provides a nonaqueous electrolyte secondary battery having a positive electrode that contains a positive electrode active material layer made up of any one of the materials for forming a positive electrode active material layer disclosed herein; a negative electrode; and a nonaqueous electrolyte. A nonaqueous electrolyte secondary battery having such a configuration exhibits excellent output characteristics, and accordingly can be preferably used herein.

### BRIEF DESCRIPTION OF THE DRAWINGS

FIG. 1 is a cross-sectional diagram illustrating schematically the internal structure of a lithium ion secondary battery according to an embodiment;

FIG. 2 is a diagram illustrating schematically the configuration of a wound electrode body of a lithium ion secondary battery according to an embodiment; and

FIG. 3 is a diagram illustrating schematically the configuration of a material for forming a positive electrode active material layer according to an embodiment.

### DETAILED DESCRIPTION

Preferred embodiments of the material for forming a positive electrode active material layer disclosed herein and of a nonaqueous electrolyte secondary battery that utilizes the material for forming a positive electrode active material layer will be explained hereafter in detail, with reference to accompanying drawings as appropriate. Any features other than the matter specifically set forth in the present specification and that may be necessary for carrying out the present specification can be regarded as instances of design matter, for a person skilled in the art, based on known techniques in the relevant technical field. The present disclosure can be realized on the basis of the disclosure of the present specification and common technical knowledge in the relevant technical field. The embodiments below are not meant to limit the art disclosed herein in any way. In the drawings depicted in the present specification, members and portions that elicit identical effects will be explained while denoted by identical reference numerals. The dimensional relationships (length, width, thickness and so forth) in the figures do not reflect actual dimensional relationships.

In the present specification a numerical value range notated as “A to B” (where A and B are arbitrary numerical values) denotes a value equal to or more than A and equal to or less than B. Therefore, the above notation includes values that are more than A and less than B.

The term “nonaqueous electrolyte secondary battery” in the present specification denotes a battery in general that can be repeatedly charged and discharged and that utilizes a nonaqueous electrolyte solution as an electrolyte. Typical examples of such nonaqueous electrolyte secondary batteries include lithium ion secondary batteries. A lithium ion secondary battery is a battery that utilizes lithium (Li) ions as electrolyte ions (charge carriers) and in which charging and discharge are accomplished through movement of lithium ions between a positive electrode and a negative electrode. In the present specification, the term “active material” denotes a material that reversibly stores and releases charge carriers.

A lithium ion secondary battery that utilizes a material for forming a positive electrode active material layer 1 according to the present embodiment will be explained first. The explanation below concerns a square lithium ion secondary battery 100 provided with a flat-shaped wound electrode body 20, but the nonaqueous electrolyte secondary battery disclosed herein is not meant to be limited to such an aspect. The nonaqueous electrolyte secondary battery disclosed herein can be constructed in the form of a lithium ion secondary battery provided with a multilayer electrode body (i.e. an electrode body resulting from alternate laying of a plurality of positive electrodes and a plurality of negative electrodes). The nonaqueous electrolyte secondary battery disclosed herein can be configured in the form of a coin-type lithium ion secondary battery, a button-type lithium ion secondary battery, a cylindrical lithium ion secondary battery or a laminate-type lithium ion secondary battery. Also, the nonaqueous electrolyte secondary battery disclosed herein can be configured in the form of a nonaqueous electrolyte secondary battery other than a lithium ion secondary battery, in accordance with a known method.

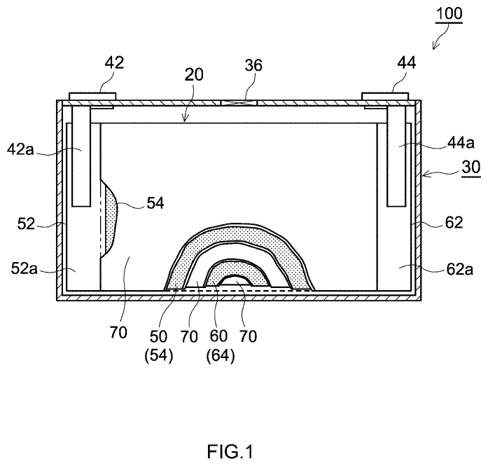

FIG. 1 is a cross-sectional diagram illustrating schematically the internal structure of a lithium ion secondary battery according to an embodiment. The lithium ion secondary battery 100 according to the present embodiment is a sealed battery constructed by accommodating a flat-shaped wound electrode body 20 and a nonaqueous electrolyte (not shown) in a flat square battery case (i.e. outer container) 30. The battery case 30 has a positive electrode terminal 42 and a negative electrode terminal 44 for external connection, and with a thin-walled safety valve 36 set to relieve internal pressure in the battery case 30 when the internal pressure rises to or above a predetermined level. The positive and negative electrode terminals 42, 44 are electrically connected to positive and negative electrode collector plates 42a, 44a, respectively. For instance, a lightweight metallic material of good thermal conductivity, such as aluminum, is used as the material of the battery case 30.

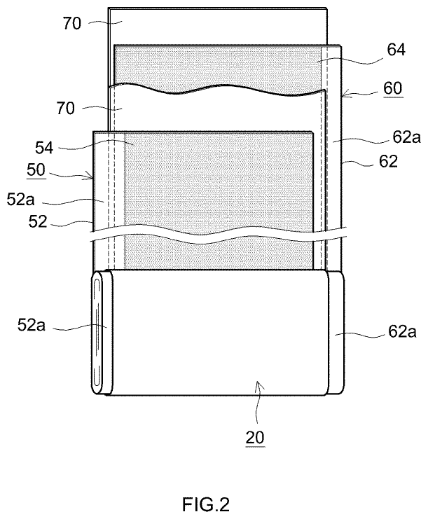

As illustrated in FIG. 1 and FIG. 2, the wound electrode body 20 has a configuration resulting from superimposing a positive electrode sheet 50 and a negative electrode sheet 60 across two elongated separator sheets 70 interposed in between, and winding of the resulting stack in the longitudinal direction. The positive electrode sheet 50 has a configuration in which a positive electrode active material layer 54 is formed, in the longitudinal direction, on one or both faces (herein both faces) of an elongated positive electrode collector 52. The negative electrode sheet 60 has a configuration in which a negative electrode active material layer 64 is formed, in the longitudinal direction, on one or both faces (herein both faces) of an elongated negative electrode collector 62. A positive electrode active material layer non-formation section 52a (i.e. exposed portion of the positive electrode collector 52 at which the positive electrode active material layer 54 is not formed) and a negative electrode active material layer non-formation section 62a (i.e. exposed portion of the negative electrode collector 62 at which the negative electrode active material layer 64 is not formed) are formed so as to respectively protrude outward from either edge of the wound electrode body 20 in a winding axis direction thereof (i.e. sheet width direction perpendicular to the longitudinal direction). The positive electrode active material layer non-formation section 52a and the negative electrode active material layer non-formation section 62a are joined to the positive electrode collector plate 42a and the negative electrode collector plate 44a, respectively.

A conventionally known positive electrode collector that is utilized in lithium ion secondary batteries can be used herein as the positive electrode collector 52; examples thereof include a sheet or foil of a metal having good conductivity (for instance aluminum, nickel, titanium or stainless steel). Aluminum foil is preferable as the positive electrode collector 52. The dimensions of the positive electrode collector 52 are not particularly limited and may be established as appropriate in accordance with the design of the battery. In a case where an aluminum foil is used as the positive electrode collector 52, the thickness of the foil is not particularly limited, and is for instance 5 or more and 35 μm or less, preferably 7 μm or more and 20 μm or less.

The positive electrode active material layer 54 is made up of the material for forming a positive electrode active material layer 1 disclosed herein (the material for forming a positive electrode active material layer 1 will be described further on). The thickness of the positive electrode active material layer 54 is not particularly limited, and is for instance 10 μm or more and 300 μm or less, preferably 20 μm or more and 200 μm or less.

A known negative electrode collector utilized in lithium ion secondary batteries may be used as the negative electrode collector 62; examples thereof include a sheet or foil of a metal having good conductivity (for instance copper, nickel, titanium or stainless steel). A copper foil is preferred as the negative electrode collector 62. The dimensions of the negative electrode collector 62 are not particularly limited, and may be established as appropriate in accordance with the design of the battery. In a case where a copper foil is used as the negative electrode collector 62, the thickness of the foil is not particularly limited, and is for instance 5 μm or more and 35 μm or less, preferably 7 μm or more and 20 μm or less.

The negative electrode active material layer 64 contains a negative electrode active material. A carbon material such as graphite, hard carbon or soft carbon can be used as the negative electrode active material. Graphite may be herein natural graphite or man-made graphite; also amorphous carbon-coated graphite in which the surface of graphite is coated with an amorphous carbon material may be used herein.

The average particle size (median size: D50) of the negative electrode active material is not particularly limited, and is for instance 0.1 μm or more and 50 μm or less, preferably 1 μm or more and 25 μm or less, and more preferably 5 μm or more and 20 μm or less.

In the present specification the term “average particle size” denotes for instance a particle size corresponding to a cumulative value of 50% from a small particle size side in a volume-basis particle size distribution based on a general laser diffraction/light scattering method.

The negative electrode active material layer 64 can contain components other than the active material, for instance a binder and a thickener. For instance, styrene butadiene rubber (SBR) or polyvinylidene fluoride (PVDF) can be used as the binder. For instance, carboxymethyl cellulose (CMC) or the like can be used as the thickener.

The content of the negative electrode active material in the negative electrode active material layer is preferably 90 mass % or more, and is more preferably 95 mass % or more and 99 mass % or less. The content of the binder in the negative electrode active material layer is preferably 0.1 mass % or more and 8 mass % or less, more preferably 0.5 mass % or more and 3 mass % or less. The content of the thickener in the negative electrode active material layer is preferably 0.3 mass % or more and 3 mass % or less, more preferably 0.5 mass % or more and 2 mass % or less.

The thickness of the negative electrode active material layer 64 is not particularly limited, and is for instance 10 μm or more and 300 μm or less, preferably 20 μm or more and 200 μm or less.

Examples of the separator sheet 70 include a porous sheet (film) made of a resin such as polyethylene (PE), polypropylene (PP), polyester, cellulose or polyamide. Such a porous sheet may have a single-layer structure, or a multilayer structure of two or more layers (for instance a three-layer structure in which PP layers are laid on both faces of a PE layer). A heat resistant layer (HRL) may be provided on the surface of the separator sheet 70.

The nonaqueous electrolyte typically contains a nonaqueous solvent and a supporting salt (electrolyte salt). For instance, various carbonates, ethers, esters, nitriles, sulfones, lactones or the like that are used in electrolyte solutions of lithium ion secondary batteries in general can be utilized, without particular limitations, as the nonaqueous solvent. Concrete examples include ethylene carbonate (EC), propylene carbonate (PC), diethyl carbonate (DEC), dimethyl carbonate (DMC), ethyl methyl carbonate (EMC), monofluoroethylene carbonate (MFEC), difluoroethylene carbonate (DFEC), monofluoromethyldifluoromethyl carbonate (F-DMC) and trifluorodimethyl carbonate (TFDMC). Such nonaqueous solvents can be used singly or in combinations of two or more types, as appropriate.

For instance a lithium salt such as LiPF₆, LiBF₄, lithium bis(fluorosulfonyl)imide (LiFSI) or the like (preferably LiPF₆) can be suitably used as the supporting salt. The concentration of the supporting salt is preferably 0.7 mol/L or more and 1.3 mol/L or less.

So long as the effect of the present disclosure is not significantly impaired thereby, the above nonaqueous electrolyte may contain various additives besides the above-described components, for instance a coating film-forming agent such as an oxalato complex; a gas generating agent such as biphenyl (BP) and cyclohexyl benzene (CHB); as well as a thickener.

The lithium ion secondary battery 100 can be produced in the same way as in known methods, except that the material for forming a positive electrode active material layer 1 explained below is used herein.

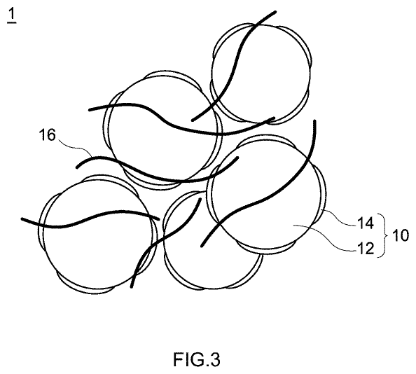

The material for forming a positive electrode active material layer 1 will be explained next. FIG. 3 is a diagram illustrating schematically the configuration of a material for forming a positive electrode active material layer 1 according to an embodiment. The material for forming a positive electrode active material layer 1 according to the present embodiment broadly contains a positive electrode active material 10, and carbon nanotubes 16. The various constituent elements will be explained next.

Positive Electrode Active Material 10

As illustrated in FIG. 3, the positive electrode active material 10 according to the present embodiment has a core portion 12 and a coating portion 14 that covers at least part of the surface of the core portion. The coating portion 14 is characterized by containing TiO₂.

(a) Core Portion 12

The core portion 12 is a particle that contains a lithium-transition metal complex oxide. The crystal structure of the lithium-transition metal complex oxide is not particularly limited, and may be for instance a layered structure, a spinel structure or an olivine structure. The lithium-transition metal complex oxide is preferably a lithium-transition metal complex oxide in which the transition metal element includes at least one from among Ni, Co and Mn; examples thereof include lithium-nickel complex oxides, lithium-cobalt complex oxides, lithium-manganese complex oxides, lithium-nickel-manganese complex oxides, lithium-nickel-cobalt-manganese complex oxides, lithium-nickel-cobalt-aluminum complex oxides and lithium-iron-nickel-manganese complex oxides.

In the present specification, the term “lithium-nickel-cobalt-manganese complex oxide” encompasses oxides having Li, Ni, Co, Mn and O as constituent elements, and also oxides that contain one or two or more additional elements, besides the foregoing. Examples of such additional elements include transition metal elements and main-group metal elements such as Mg, Ca, Al, V, Cr, Y, Zr, Nb, Mo, Hf, Ta, W, Na, Fe, Zn and Sn. Other examples of additional elements include metalloid elements such as B, C, Si and P, and non-metal elements such as S, F, Cl, Br and I. This applies also to an instance where a lithium-nickel complex oxide, lithium-cobalt complex oxide, lithium-manganese complex oxide, lithium-nickel-manganese complex oxide, lithium-nickel-cobalt-manganese complex oxide, lithium-nickel-cobalt-aluminum complex oxide or lithium-iron-nickel-manganese complex oxide described above is used as the core portion 12.

Preferably, the lithium-nickel-cobalt-manganese complex oxide has the composition represented by Formula (II) below.

Li₁₊ₓNi_{y}Co_{z}Mn_{(1-y-z)}M_{α}O_{2-β}Q_{β} (II)

In Formula (II), x, y, z, α and β respectively satisfy 0≤x≤0.7, 0.1<y<0.9, 0.1<z<0.4, 0≤α≤0.1 and 0≤β≤0.5. Further, M is at least one element selected from the group consisting of Zr, Mo, W, Mg, Ca, Na, Fe, Cr, Zn, Sn and Al. Further, Q is at least one element selected from the group consisting of F, Cl and Br. From the viewpoint of energy density and thermal stability, preferably y and z respectively satisfy 0.3≤y≤0.5 and 0.2≤z≤0.4. Further, x preferably satisfies 0≤x≤0.25, more preferably 0≤x≤0.15, and yet more preferably x is 0. Herein a preferably satisfies 0≤α≤0.05, and more preferably α is 0. Further, β satisfies 0≤β≤0.1, and more preferably β is 0.

The shape of the core portion 12 is not particularly limited, so long as the effect of the art disclosed herein can be brought out, and the core portion 12 may adopt a spherical shape, a plate shape, a needle shape or an indefinite shape. The core portion 12 may be in the form of secondary particles resulting from aggregation of primary particles, or may be in the form of hollow particles. The average particle size of the core portion 12 is for instance 0.05 μm or more and 20 μm or less, preferably 1 μm or more and 20 μm or less, and more preferably 3 μm or more and 15 μm or less.

The method for producing the core portion 12 may involve for instance producing a precursor of a lithium-transition metal complex oxide (for example a metal hydroxide) by crystallization or the like, followed by introduction of lithium into the precursor (see examples described below).

(b) Coating Portion 14

A coating portion 14 is formed on at least part of the surface of the core portion 12. Further, the coating portion 14 contains TiO₂. Known crystal structures of TiO₂ include those of anatase type (tetragonal crystal), of rutile type (tetragonal crystal) and of brookite type (orthorhombic crystal). The coating portion 14 may contain one or two or more types of TiO₂ having a crystal structure such as those described above, so long as the effect of the art disclosed herein is brought out. For instance, a commercially available product can be purchased and used as the TiO₂.

The shape of the TiO₂ is not particularly limited, so long as the effect of the art disclosed herein is brought out, and the TiO₂ may adopt for instance a spherical shape, a plate shape, a needle shape or an indefinite shape. The average particle size of the TiO₂ is not particularly limited, so long as the effect of the art disclosed herein is brought out, and can be set to about 0.1 to 200 nm (for instance to about 100 nm).

The coating amount of TiO₂ on the surface of the positive electrode active material 10 (in other words the Ti coverage ratio on the surface of the positive electrode active material 10) is not particularly limited, so long as the effect of the art disclosed herein is brought out, and can be typically set to lie in the range from 0.01 to 30%. From the viewpoint of suitably eliciting a reaction resistance lowering effect, the Ti coverage ratio is preferably set to be 0.1% or more, more preferably 0.5% or more, or 1.0% or more, or 2.0% or more, or 3.0% or more, and yet more preferably 5.0% or more. When the Ti coverage ratio is excessively high, however, the reaction resistance lowering effect derived from Ti coating tends to drop, given that TiO₂ itself is an insulator. Therefore, the coverage ratio can be preferably set to be 25% or less, more preferably 21% or less (for instance 20% or less), and yet more preferably 15% or less (for instance 14% or less).

The Ti coverage ratio can be determined by quantifying the proportion of elements on the surface of the positive electrode active material particles, through analysis based on X-ray photoelectron spectroscopy (XPS). Specifically, the element ratio of titanium (Ti) on the positive electrode active material particle surface and the element ratio of a metal element (Me) other than Li from among the elements that make up the core portion, are calculated in “atomic %” units, whereupon the Ti coverage ratio can be calculated on the basis of equation (I) below using the value of the element ratio of Ti expressed as “atomic %” and the value of the element ratio of Me expressed as “atomic %”.

Ti coverage ratio (%)={Ti element ratio/(Ti element ratio+Me element ratio)}×100 (I)

The thickness of the coating portion 14 is not particularly limited so long as the effect of the art disclosed herein is brought out, and can be set to lie in the range from about 0.1 nm to 500 nm (for instance from 1 nm to 200 nm, or from 10 nm to 100 nm). The thickness of the coating portion 14 can be for instance worked out by observing a cross section of the positive electrode active material 10 by energy dispersive X-ray spectroscopy with the use of a transmission electron microscope (TEM-EDX).

Carbon Nanotubes 16

Carbon nanotubes are a fibrous form or carbon having a structure in which graphene that constitutes a carbon hexagonal network is rolled into tubes. Carbon nanotubes have a high aspect ratio and exhibit excellent electron conductivity. Examples of carbon nanotube types include single-walled carbon nanotubes (SWCNTs) formed out of one layer of graphene, and multi-walled carbon nanotubes (MWCNTs) formed out of two or more layers of graphene. Multi-walled carbon nanotubes can be preferably used among the foregoing, since these exhibit excellent thermal and chemical stability.

The average length of the carbon nanotubes 16 is not particularly limited, so long as the effect of the art disclosed herein is brought out, and can be set for instance to from about 1 to 1000 μm (for instance from 10 to 500 μm). The length distribution of carbon nanotubes can be set for instance to from about 1 μm to 1000 μm (for instance from 10 to 50 μm), and the BET specific surface area can be set to from about 100 m²/g to 500 m²/g. The average diameter of the carbon nanotubes 16 is not particularly limited, so long as the effect of the art disclosed herein is brought out, and can be set to from about 0.1 to 100 nm (for instance about 10 nm).

As to the carbon purity of the carbon nanotubes 16, carbon nanotubes of high purity are preferably used, since a higher purity of the carbon nanotubes entails fewer crystal structure defects and better conductivity. The purity of the carbon nanotubes is preferably 95% or more, more preferably 97% or more, and particularly preferably 99% or more (for instance 99.5%, or 99.9%).

The content of the carbon nanotubes 16 is not particularly limited, so long as the effect of the art disclosed herein is brought out, and can be set to from about 0.01 to 10 mass %, relative to 100 mass % as the total solids of the material for forming a positive electrode active material layer 1. From the viewpoint of suitably lowering reaction resistance, the content can be preferably set to for instance 0.05 mass % or more, more preferably 0.1 mass % or more, and yet more preferably 1 mass % or more. From the viewpoint of preferably securing energy density in the lithium ion secondary battery 100, the content can be preferably set for instance to 8 mass % or less, more preferably 5 mass % or less.

Commercially available carbon nanotubes may be purchased and used as the carbon nanotubes 16; alternatively carbon nanotubes produced in accordance with a conventionally known carbon nanotube production method may be used as the carbon nanotubes 16. Examples of such methods include chemical vapor deposition (CVD), arc discharge and laser evaporation.

The material for forming a positive electrode active material layer 1 may contain components other than the positive electrode active material 10 and the carbon nanotubes 16, so long as the effect of the art disclosed herein is brought out. Examples of such components include for instance include trilithium phosphate, a conductive material and a binder. For instance, carbon black such as acetylene black (AB) or other carbon materials (for example graphite) can be suitably used as a conductive material. For instance, polyvinylidene fluoride (PVDF) or the like can be used as the binder.

The content of the positive electrode active material 10 in the material for forming a positive electrode active material layer 1 is not particularly limited, so long as the effect of the art disclosed herein is brought out, and can be set to about 70 mass % or more, preferably to from 80 to 97 mass %, and yet more preferably to from 85 to 96 mass %. The content of trilithium phosphate in the material for forming a positive electrode active material layer 1 is not particularly limited, so long as the effect of the art disclosed herein is brought out, and can be set to from about 1 to 15 mass %, for instance from 2 to 12 mass %. The content of the conductive material in the material for forming a positive electrode active material layer 1 is not particularly limited, so long as the effect of the art disclosed herein is brought out, and can be set to from about 1 to 15 mass %, for instance from 3 to 13 mass %. The content of the binder in the material for forming a positive electrode active material layer is not particularly limited, so long as the effect of the art disclosed herein is brought out, and can be set to from about 1 to 15 mass %, for instance from 1.5 to 10 mass %.

Examples of the method for producing the positive electrode active material 10 include a method of mixing the core portion 12 and TiO₂ using a mortar or the like (see examples described below). The Ti coverage ratio can be modified for instance by changing the addition amount of TiO₂ to the core portion 12. Although not limited thereto for instance a positive electrode active material having a Ti coverage ratio of X % can be obtained by preparing a core portion and TiO₂ to a mass ratio of about 100:X+1, with mixing the foregoing. The positive electrode active material disclosed herein can be produced by charging a predetermined amount of the core portion and TiO₂ into a mechanochemical apparatus, and performing a mechanochemical treatment (for instance at a rotation speed of 6000 rpm, for 30 minutes).

The lithium ion secondary battery 100 that utilizes the material for forming a positive electrode active material layer 1 configured as described above can be used in various applications. For instance, the lithium ion secondary battery 100 can be suitably used as a high-output power source (drive power source) for motors, mounted in vehicles. The type of vehicle is not particularly limited, and typical examples thereof include automobiles, for instance plug-in hybrid electric vehicles (PHEV), hybrid electric vehicles (HEV) and battery electric vehicles (BEV). The lithium ion secondary battery 100 is typically used in the form of an assembled battery resulting from electrical connection of a plurality of batteries.

Examples pertaining to the present disclosure will be explained below, but the present disclosure is not meant to be limited to the particulars illustrated in the examples.

Production of a Positive Electrode Active Material (Preparation of a Core Portion)

An aqueous solution was prepared in which a sulfate of a metal other than Li was dissolved in water. In a case for instance where LiNi_{1/3}Co_{1/3}Mn_{1/3}O₂ particles having a layered structure were produced as the core portion, an aqueous solution was prepared by mixing nickel sulfate, cobalt sulfate and manganese sulfate so that the content of Ni, Co and Mn was 1:1:1 in molar ratio. Then NaOH and aqueous ammonia were added for neutralization, to thereby elicit precipitation of a complex hydroxide, as a precursor of the core portion, that contained metals other than Li. The obtained complex hydroxide and lithium carbonate were mixed at a predetermined proportion. In a case for instance where LiNi_{1/3}Co_{1/3}Mn_{1/3}O₂ particles having a layered structure were produced as the positive electrode active material particle, the complex hydroxide and lithium carbonate were mixed to a molar ratio of the total of Ni, Co plus Mn, relative to Li, of 1:1. The mixture was fired at 870° C. for 15 hours in an electric furnace. After cooling down to room temperature (25° C.±5° C.) in the electric furnace, the fired product was crushed to yield a spherical core portion (average particle size: 5.0 μm) resulting from aggregation of primary particles.

In this manner LiNi_{1/3}Co_{1/3}Mn_{1/3}O₂, LiCoO₂, LiMn₂O₄, LiNiO₂, LiNi_{0.5}Mn_{1.5}O₄ and LiNi_{0.8}Co_{0.15}Al_{0.05}O₂ were produced as respective core portions.

Positive Electrode Active Materials of Samples 1 and 7

A core portion (LiNi_{1/3}CO_{1/3}Mn_{1/3}O₂) produced as described above was used, as it was, as the positive electrode active material of Samples 1 and 7.

Positive Electrode Active Materials of Samples 2 to 6 and 8 to 13

A core portion (LiNi_{1/3}Co_{1/3}Mn_{1/3}O₂) produced as described above was mixed for 30 minutes with TiO₂ (rutile type, average particle size: about 100 nm) using a mortar. The coverage ratio of TiO₂ was modified herein by changing the addition amount of TiO₂ relative to the core portion. As an example, the positive electrode active material according to Sample 8 was produced by preparing a core portion and TiO₂, to a mass ratio of about 100:6, and by mixing the foregoing. The positive electrode active materials of Samples 2 to 6 and 8 to 13 were produced in this manner.

Measurement of the Ti Coverage Ratio on the Surface of the Positive Electrode Active Material

In a glove box, 100 mg of each positive electrode active material produced as described above were placed on a sample pan made of aluminum, and were pressed in a tablet molding machine, to produce a respective measurement sample. Each measurement sample was attached to an XPS analysis holder, and an XPS measurement was performed under the conditions below using an XPS analyzer “PHI 5000 VersaProbe II” (by ULVAC-PHI Inc.). A composition analysis of each element under measurement was carried out, and the proportion of the element was calculated as “atomic %”. The coverage ratio (%) was calculated, using the obtained values, on the basis of the equation: {Ti element ratio/(Ti element ratio+Me element ratio)}×100. In the equation, Me denotes a metal element other than Li in the positive electrode active material; for instance Me is Ni, Co and Mn in the case of LiNi_{1/3}Co_{1/3}Mn_{1/3}O₂). The results are set out in the column “Ti coverage ratio” of Table 1.

X-ray source: AlKα monochromatic light

Irradiation range: φ100 μm HP (1400×200)

Current voltage: 100 W, 20 kV

Neutralization gun: ON

Pass energy: 187.85 eV (wide), 46.95 to 117.40 eV (narrow)

Step: 0.4 eV (wide), 0.1 eV (narrow)

Shift correction: C—C, C—H (C1s, 284.8 eV)

Peak information: Handbook of XPS (ULVAC-PHI)

Production of Lithium-Ion Secondary Batteries for Evaluation

There were prepared (preparation of a material for forming a positive electrode active material layer) each positive electrode active material according to Samples 1 to 13 produced as described above, carbon nanotubes (multi-walled carbon nanotubes, length: 10 to 50 μm, diameter: 10 nm) and acetylene black (AB) as a conductive material, and polyvinylidene fluoride (PVDF) a binder. The foregoing were mixed with N-methylpyrrolidone (NMP) as a dispersion medium, using a Disper, to prepare a paste for forming a respective positive electrode active material layer. In this case, the mass ratio of the active material, AB and PVDF were set to 90:5:5, and carbon nanotubes were added so as to achieve the mass % given in the corresponding column of Table 1, relative to 100 mass % as the total solids of the active material, AB plus PVDF. The solids concentration was set to 56 mass %. This paste was applied onto both faces of an aluminum foil using a die coater, with drying for 10 minutes at 80° C., followed by pressing at 30 tons, to produce a respective positive electrode sheet.

Further, natural graphite (C) as a negative electrode active material, styrene butadiene rubber (SBR) as a binder, and carboxymethyl cellulose (CMC) as a thickener were mixed, at a mass ratio of C:SBR:CMC=98:1:1, in ion-exchanged water, to prepare a paste for forming a negative electrode active material layer. This paste was applied onto both faces of a copper foil using a die coater, with drying followed by pressing, to produce a negative electrode sheet.

Further, two porous polyolefin sheets having a three-layer structure of PP/PE/PP and a thickness of 24 μm were prepared as separator sheets.

Each produced positive electrode sheet and negative electrode sheet, and the two prepared separator sheets, were superimposed and wound, to produce a wound electrode body. Respective electrode terminals were attached by welding to the positive electrode sheet and the negative electrode sheet of the produced wound electrode body, and the whole was accommodated in a battery case having a filling port.

A nonaqueous electrolyte solution was then injected through the filling port of the battery case, and the filling port was hermetically sealed with a sealing lid. As the nonaqueous electrolyte solution there was used a solution resulting from dissolving LiPF₆ as a supporting salt, to a concentration of 1.0 mol/L, in a mixed solvent that contained ethylene carbonate (EC), ethyl methyl carbonate (EMC) and dimethyl carbonate (DMC) at a volume ratio of 1:1:1. Lithium ion secondary batteries for evaluation according to Samples 1 to 13 were produced in the above manner.

Measurement of Reaction Resistance

Each lithium ion secondary battery for evaluation was activated and voltage was adjusted to 3.7 V. Each lithium ion secondary battery for evaluation was placed in a temperature environment at −10° C., and the impedance of the battery was measured in a state where an AC voltage having a voltage amplitude of 5 mV was applied to the battery, in a frequency range from 0.01 Hz to 100,000 Hz. The diameter R of the arc of an obtained Cole-Cole plot was then determined as the reaction resistance (Rct). The ratio of Rct of each sample and other comparative examples, relative to 1 as the Rct of Sample 1, was worked out. The results are given in the column “Reaction resistance ratio” in Table 1.

TABLE 1
Table 1

| | | | Addition | |
|---|---|---|---|---|
| | Type of core | | amount | |
| | portion in | Ti | of carbon | Reaction |
| | positive electrode | coverage | nanotubes | resistance |
| | active material | ratio [%] | [mass %] | ratio |
| Sample 1 | LiNi_{1/3}Co_{1/3}Mn_{1/3}O₂ | 0 | 0 | 1 |
| Sample 2 | | 0.5 | 0 | 0.89 |
| Sample 3 | | 1.2 | 0 | 0.85 |
| Sample 4 | | 1.7 | 0 | 0.86 |
| Sample 5 | | 5.6 | 0 | 1.16 |
| Sample 6 | | 12.3 | 0 | 1.30 |
| Sample 7 | | 0 | 1 | 0.93 |
| Sample 8 | | 5.4 | 1 | 0.83 |
| Sample 9 | | 11.5 | 1 | 0.75 |
| Sample 10 | | 12.7 | 1 | 0.73 |
| Sample 11 | | 12.7 | 2 | 0.69 |
| Sample 12 | | 13.1 | 5 | 0.70 |
| Sample 13 | | 20.8 | 5 | 0.95 |

Assessment of the Type of the Core Portion (Samples 14, 16, 18, 20 and 22)

The core portions LiCoO₂, LiMn₂O₄, LiNiO₂, LiNi_{0.5}Mn_{1.5}O₄ and LiNi_{0.8}Co_{0.15}Al_{0.05}O₂ produced as described above were respectively used as the positive electrode active materials according to Samples 14, 16, 18, 20 and 22.

Samples 15, 17, 19, 21 and 23

The core portions LiCoO₂, LiMn₂O₄, LiNiO₂, LiNi_{0.5}Mn_{1.5}O₄ and LiNi_{0.8}Co_{0.15}Al_{0.05}O₂ produced as described above were mixed with rutile-type TiO₂ for 30 minutes, using a mortar. The positive electrode active materials according to Samples 15, 17, 19, 21 and 23 were produced in this manner.

lithium ion secondary batteries for evaluation were produced in the same way as above using the positive electrode active materials according to Samples 14 to 23, and reaction resistance (Rct) was evaluated in the same way as above. The Rct ratio of Samples 15, 17, 19, 21 and 23 were worked out relative to 1 as the Rct of the respective lithium ion secondary batteries for evaluation according to Samples 14, 16, 18, 20 and 22. The results are given in the column “Reaction resistance ratio” in Table 2.

TABLE 2
Table 2

| | | | Addition | |
|---|---|---|---|---|
| | Composition of | | amount | |
| | core portion in | Ti | of carbon | Reaction |
| | positive electrode | coverage | nanotubes | resistance |
| | active material | ratio [%] | [mass %] | ratio |
| Sample 1 | LiNi_{1/3}Co_{1/3}Mn_{1/3}O₂ | 0 | 0 | 1 |
| Sample 10 | | 12.7 | 1 | 0.73 |
| Sample 14 | LiCoO₂ | 0 | 0 | 1 |
| Sample 15 | | 11.5 | 1 | 0.75 |
| Sample 16 | LiMn₂O₄ | 0 | 0 | 1 |
| Sample 17 | | 11.3 | 1 | 0.79 |
| Sample 18 | LiNiO₂ | 0 | 0 | 1 |
| Sample 19 | | 13.4 | 1 | 0.80 |
| Sample 20 | LiNi_{0.5}Mn_{1.5}O₄ | 0 | 0 | 1 |
| Sample 21 | | 15.5 | 1 | 0.76 |
| Sample 22 | LiNi_{0.8}Co_{0.15}Al_{0.05}O₂ | 0 | 0 | 1 |
| Sample 23 | | 12.5 | 1 | 0.82 |

As Table 1 reveals, the lithium ion secondary batteries according to Samples 8 to 12, which utilized a material for forming a positive electrode active material layer that contained carbon nanotubes and a positive electrode active material provided with a coating portion containing TiO₂, exhibited a suitable reduction in reaction resistance as compared with Sample 1 (lithium ion secondary battery using a material for forming a positive electrode active material layer that contained a core portion alone), Samples 2 to 6 (lithium ion secondary batteries using a material for forming a positive electrode active material layer that contained a positive electrode active material alone) and Sample 7 (lithium ion secondary battery using a material for forming a positive electrode active material layer that contained a core portion and carbon nanotubes).

It was also found that reaction resistance was effectively reduced in aspects with a high Ti coverage ratio (for instance from 5 to 21%), in the lithium ion secondary batteries according to Samples 8 to 13 in which carbon nanotubes were added.

As Table 2 reveals, it was also found that reaction resistance was suitably reduced in the lithium ion secondary batteries according to Samples 10, 15, 17, 19, 21 and 23, as compared with the lithium ion secondary batteries according to Samples 1, 14, 16, 18, 20 and 22. This indicates that a reaction resistance lowering effect can be achieved regardless of the composition and crystal structure of the core portion of the positive electrode active material.

The above reveals that the material for forming a positive electrode active material layer disclosed herein allows suitably reducing reaction resistance, and allows improving the output characteristics of a nonaqueous electrolyte secondary battery that utilizes this material.

Concrete examples of the present disclosure have been explained in detail above, but the examples are merely illustrative in nature, and are not meant to limit the scope of the claims in any way. The art set forth in the claims encompasses various alterations and modifications of the concrete examples illustrated above.

1. A material for forming a positive electrode active material layer comprising:
a positive electrode active material; and
carbon nanotubes, wherein:
the positive electrode active material comprises:
a core portion containing a lithium-transition metal complex oxide; and
a coating portion that covers at least part of the surface of the core portion, wherein:
the coating portion contains TiO₂.

2. The material for forming a positive electrode active material layer according to claim 1, wherein:
a Ti coverage ratio is from 5 to 21%, wherein the Ti coverage ratio is calculated by following equation:
Ti coverage ratio (%)={Ti element ratio/(Ti element ratio+Me element ratio)}×100 (I), where:
Ti element ratio: An element ratio (atomic %) of titanium (Ti) on the surface of the positive electrode active material being calculated by XPS analysis,
Me element ratio: An element ratio (atomic %) of a metal element (Me) other than an alkali metal from among the metal elements that make up the core portion being calculated by XPS analysis.

3. The material for forming a positive electrode active material layer according to claim 1, wherein:
the carbon nanotubes include multi-walled carbon nanotubes.

4. The material for forming a positive electrode active material layer according to claim 1, wherein:
the content of the carbon nanotubes is 5 mass % or less relative to 100 mass % as the total solids of the material for forming a positive electrode active material layer.

5. A nonaqueous electrolyte secondary battery comprising:
a positive electrode;
a negative electrode; and
a nonaqueous electrolyte, wherein:
the positive electrode contains a positive electrode active material layer made up of the material for forming a positive electrode active material layer according to claim 1.
